(19) United States
(12) Patent Application Publication
(10) Pub. No.: US 2008/0089670 A1
(43) Pub. Date: Apr. 17, 2008

(54) RECORDING APPARATUS

(75) Inventor: Shingo Nozawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/869,533

(22) Filed: Oct. 9, 2007

(30) Foreign Application Priority Data
Oct. 12, 2006 (JP) 2006-279160

(51) Int. Cl. H04N 7/26

(52) U.S. Cl. 386/109

(57) ABSTRACT

A recording apparatus includes a first encoding unit for encoding a video signal under a first encoding system and generating first encoded data; a recording unit for recording the first encoded data onto a recording medium in a first record format; a second encoding unit for encoding the video signal under a second encoding system different from the first encoding system and generating second encoded data; a finalization unit for performing finalization processing based on a finalization processing instruction for the recording medium storing the first encoded data; and a controlling unit for controlling the second encoding unit so the second encoded data is generated by using the first encoded data and controlling the recording unit so the second encoded data is recorded onto the recording medium storing the first encoded data in a second record format different from the first record format based on the finalization processing instruction.

### BACKGROUND OF THE INVENTION

1. Field of the Invention

The present invention relates to a recording apparatus and particularly relates to an apparatus configured to record a video signal in a recording medium.

2. Description of the Related Art

In recent years, as the digital-signal-processing technology advances, it has become possible to efficiently encode a large amount of digital information including video information, still-image information, sound information, and so forth, so as to record the encoded information in a small recording medium and/or transfer the encoded information via a communication medium. A recording apparatus, an image-pickup apparatus, and so forth that can easily encode a high-quality video signal and externally transmit the encoded video signal immediately have been developed by using the above-described technologies.

Recently, recorders, video cameras, and so forth configured to encode and record image data and/or sound data onto a recording-type optical disk including a digital versatile disk (DVD)-recordable (R), a DVD-rewritable (RW), and so forth have become available. The above-described apparatuses are highly compatible with a DVD player. That is to say, video data and/or sound data recorded onto an optical disk by using the above-described apparatuses can be reproduced with a widely available DVD player. The above-described technology is disclosed in Japanese Patent Laid-Open No. 2003-163867, for example.

Additionally, the research and development of a recording medium and/or a recording system are further advancing. Namely, a large-capacity advanced recording medium is nearing practical use, where the large-capacity advanced recording medium includes a DVD medium on which information (data) can be recorded by using laser light with a wavelength shorter than that of the currently used laser light.

On the other hand, the encoding technology used to compress a video signal is also advancing so that new encoding systems superior to MPEG-2 Systems used, as an encoding system used for a DVD, are developed one after another. A record format using the new encoding systems is used for the above-described large-capacity advanced recording medium. Additionally, the above-described new encoding systems are used for known recording mediums including the DVD medium or the like, so as to record high-quality video signals reproduced over a long time period.

However, when a video signal is recorded onto a known DVD medium under a new encoding system and/or in a new format, it is difficult for a known DVD player which is not ready for the new system and/or format to recognize information recorded onto the DVD medium.

As a result, it is difficult to reproduce the recorded video signal.

Therefore, many DVD players may display messages reading “This medium is broken”, “No data is recorded onto this medium”, “This medium is not formatted”, and so forth, so as to warn the users of the DVD players.

In that case, even though video data ready for the new encoding system is properly recorded onto a recording medium in the new format, the warning may make the user determine that the recording medium has a problem.

As a result, the user may abandon the recording medium by erroneously determining that the recording medium is broken, or initialize the recording medium by erroneously determining that the recording medium is unused.

### SUMMARY OF THE INVENTION

Accordingly, the present invention has been achieved to easily recognize that a plurality of video-data items is recorded in different record formats.

According to an aspect of the present invention, a recording apparatus includes a first encoding unit configured to encode a transmitted first video signal under a first encoding system and generate first encoded data; a recording unit configured to record the generated first encoded data onto a recording medium in a first record format; a second encoding unit configured to encode the first video signal under a second encoding system different from the first encoding system and generate second encoded data; a finalization unit configured to perform finalization processing for the recording medium in the first record format based on an instruction to perform the finalization processing for the recording medium storing the first encoded data; and a controlling unit configured to control the second encoding unit so that the second encoded data is generated by using the first encoded data recorded onto the recording medium and control the recording unit so that the generated second encoded data is recorded onto the recording medium storing the first encoded data in a second record format different from the first record format based on the instruction to perform the finalization processing for the recording medium storing the first encoded data.

Further features of the present invention will become apparent from the following description of exemplary embodiments with reference to the attached drawings.

### BRIEF DESCRIPTION OF THE DRAWINGS

FIG. 1 is a block diagram illustrating an example configuration of an image-pickup apparatus using a signal-processing device according to a first embodiment of the present invention.

FIG. 2 is an example system under which data is stored in a recording medium according to the first embodiment.

FIG. 3 shows an example system under which data is stored in the recording medium in the second record format.

FIG. 4 is a flowchart showing finalization-processing procedures performed according to the first embodiment.

FIG. 5 shows an example display-screen image displayed according to the first embodiment.

FIG. 6 is a block diagram illustrating an example configuration of a video-recording-and-reproducing apparatus using a signal-processing device according to a second embodiment of the present invention.

FIG. 7 is a block diagram showing computer functions that can achieve the signal-processing device according to the second embodiment.

### DESCRIPTION OF THE EMBODIMENTS

Hereinafter, embodiments of the present invention will be described with reference to the attached drawings.

### First Embodiment

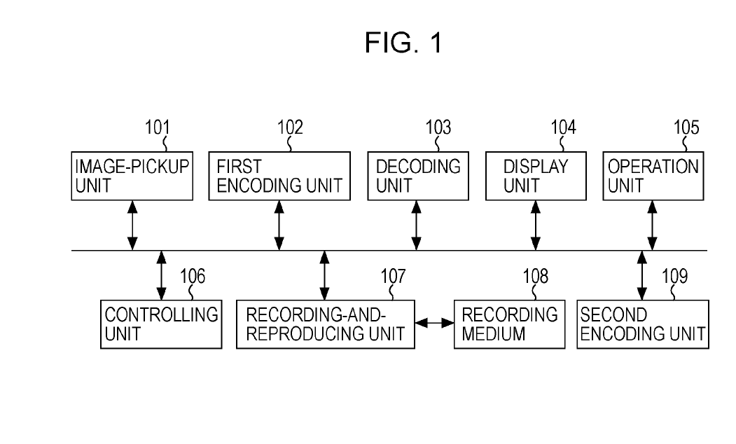

FIG. 1 is a block diagram showing an example configuration of an image-pickup apparatus according to a first embodiment of the present invention.

In FIG. 1, an image-pickup unit 101, a first encoding unit 102, a decoding unit 103, a display unit 104, an operation unit 105, a controlling unit 106, a recording-and-reproducing unit 107, a removable recording medium 108, and a second encoding unit 109 are provided.

The image-pickup unit 101 performs photoelectric conversion for data on an optical image of a subject so that the optical-image data is converted into a video signal, and externally transmits the video signal. The first encoding unit 102 encodes the transmitted video signal under the first encoding system and generates the first code string (encoded data). The decoding unit 103 decodes the first code string read from the recording medium 108 via the recording-and-reproducing unit 107.

The display unit 104 displays an image relating to the video signal externally transmitted from the image-pickup unit 101 and the video signal that is read from the recording medium 108 and that is decoded by the decoding unit 103, and displays an operation image including a menu image or the like. The operation unit 105 allows a user to specify an operation performed in the image-pickup apparatus, for example. The controlling unit 106 controls each of functional units provided in the image-pickup apparatus according to an operation or the like performed for the operation unit 105.

The recording-and-reproducing unit 107 records a code string onto the removable recording medium 108, the code string being obtained by encoding a video signal, and/or reproduces the recorded code string from the recording medium 108. Further, the recording-and-reproducing unit 107 can record and reproduce sound data and/or predetermined information onto and/or from the recording medium 108. The removable recording medium 108 is a writable recording medium. For example, according to the above-described embodiment, a disk (digital-versatile-disk (DVD) medium) including a DVD-recordable (R), which is a write-once DVD, a DVD-rewritable (RW), which is a rewritable DVD, and so forth is used, as the removable recording medium 108. However, other mediums may be used, without being limited to the above-described embodiment.

The second encoding unit 109 encodes a video signal transmitted thereto under the second encoding system and generates the second code string (encoded data).

Here, the first encoding system allows for obtaining a high-quality video signal by using a code amount smaller than that used for the second encoding system. The second encoding system is a general-purpose encoding system used by known reproducing devices supporting the second encoding system, the known reproducing devices being widely available.

According to the above-described embodiment, the H.264 (Motion Picture Experts Group (MPEG) 4 Advanced Video Coding (AVC)) system is used, as the first encoding system, for example, and MPEG-2 Systems are used, as the second encoding system. However, other systems may be used without being limited to the above-described embodiment.

The image-pickup apparatus according to the above-described embodiment operates when the user operates the operation unit 105 while looking at the display unit 104 and the controlling unit 106 controls each of blocks provided in the image-pickup apparatus in response to the above-described operations.

Namely, when a photographing operation is performed for the operation unit 105 so that photographing operations are started, the image-pickup unit 101 converts data on an optical image of the subject into a video signal and externally transmits the video signal, and the first encoding unit 102 encodes the video signal externally transmitted from the image-pickup unit 101 under the first encoding system. Subsequently, the first code string is obtained, where the first code string is obtained by encoding the video signal obtained through the photographing under the first encoding system.

The first code string obtained through the encoding performed by the first encoding unit 102 is converted into data generated in the form corresponding to the first record format by the controlling unit 106. Then, the recording-and-reproducing unit 107 records the data onto the recording medium 108.

The above-described photographing procedures are performed repeatedly so that data items relating to video signals obtained through the photographing (the first code string) are recorded onto the recording medium 108 in sequence.

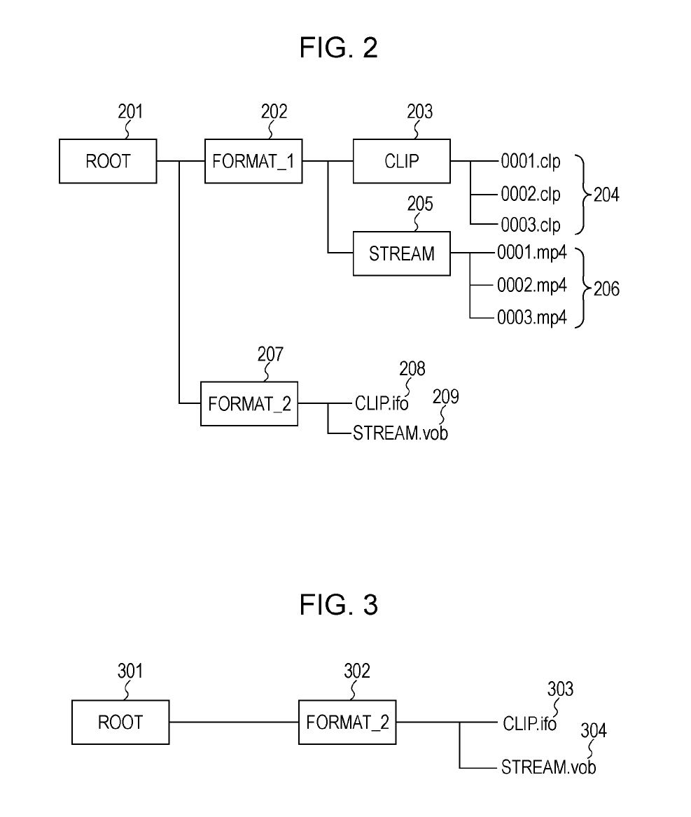

Here, file-data items (data strings) recorded in the first record format are stored in the recording medium 108 in a form shown in FIG. 2. More specifically, the file-data items are stored in the form of a tree structure shown in FIG. 2. According to the above-described tree structure, directories 202, 203, and 205, and files 204 and 206 are arranged under a root directory (ROOT) 201.

That is to say, according to the above-described embodiment, a series of code strings is stored, as a single file, where the code strings correspond to the photographing procedures, namely, from when the photographing is started to when the photographing is stopped. Then, the first code strings are recorded one after another in the stream directory (STREAM) 205 provided under the directory (FORMAT_1) 202 indicating the first record format, as the stream files 206, where the first code string is generated every time the photographing is performed.

Further, according to the above-described embodiment, every time the first code string is recorded, a clip-information file relating to the first code string is generated and recorded onto the recording medium 108. The clip-information file includes time-map information or the like showing the correspondence of a time elapsed from the head of the first code string corresponding to the clip-information file and the position of the clip-information file recorded onto the recording medium 108. The controlling unit 106 generates the clip-information file in synchronization with operations performed to record the first code string.

Then, the recording-and-reproducing unit 107 records the clip-information files 204 corresponding to the stream files 206 one after another in the clip directory (CLIP) 203 provided under the directory (FORMAT_1) 202 in the above-described manner.

Further, according to the above-described embodiment, a video signal obtained through photographing is encoded under the second encoding system provided in addition to the first encoding system so that the second code string is generated. The second code string can be recorded onto the recording medium 108 in the second record format. Further, according to the above-described embodiment, the second encoding system is determined to be MPEG-2 Systems, as described above, and the second record format is determined to be a DVD-video format.

After selecting the second encoding system by operating the operation unit 105, the user issues an instruction to start photographing. Subsequently, a video signal obtained by the image-pickup unit 101 is encoded by the second encoding unit 109, so that the video signal obtained through the photographing is encoded under the second encoding system and the second code string is obtained. The second code string obtained through the encoding performed by the second encoding unit 109 is converted into data generated in the form corresponding to the second record format by the controlling unit 106. After that, the recording-and-reproducing unit 107 records the data onto the recording medium 108 in the second record format.

FIG. 3 shows an example storage system under which each of files (data strings) is stored in the recording medium 108, where each of the files is recorded in the second record format. Each of the files recorded in the second record format is stored in the form of a tree structure including directory 302 and files 303 and 304 that are arranged under a root directory (ROOT) 301. Namely, a series of code strings is stored, as a single file, where the code strings correspond to the photographing procedures, namely, from when the photographing is started to when the photographing is stopped. Further, the stream file 304 and the clip-information file 303 corresponding thereto are recorded in the directory (FORMAT_2) 302 indicating the second record format.

In the above-described embodiment, when the recording medium 108 recording no data is inserted, the user selects either the first encoding system or the second encoding system, so as to encode and record a video signal under the selected encoding system. Then, the user initializes the recording medium 108 recording no data under the selected encoding system and in the record format corresponding to the selected encoding system.

After the encoding system is set, a video signal is encoded under the selected encoding system and recorded onto the recording medium 108 recording no data.

After the video signal is recorded onto the recording medium 108 in the above-described manner, the user can issue an instruction to perform finalization processing (finish processing) by operating the operation unit 105.

The finalization processing is performed to record predetermined data specified in a record format, such as management information, onto a disk, and record invalid data onto free space of a recording medium in the record format. Further, the finalization processing allows for adding an operation-menu image used to reproduce the data by using a player.

By performing the above-described finalization processing, it becomes possible to pull a DVD out of the image-pickup apparatus and reproduce data recorded onto the DVD.

Thus, the video signal is encoded under the first encoding system and the recording medium recording the encoded video signal in the first record format is finalized. As a result, it becomes possible to reproduce video data by using a player that can reproduce data recorded in the first record format.

However, it is difficult to reproduce recorded video data by using a player that does not support the first record format.

That is to say, when a recording medium recording a video signal in the first record format is inserted into a known player which is widely available at present, such as a DVD player, and an attempt to reproduce the video signal is made, it is difficult to identify the record format and/or the encoding system.

In that case, it is highly possible that the user erroneously determines that the recording medium is broken and/or no data is recorded onto the recording medium.

Further, if details on file arrangement performed according to the first record format are different from those on file arrangement performed according to the second record format used for the known player and/or the first encoding system is different from the second encoding system, there is no compatibility between the first record format and the second record format.

Therefore, according to the above-described embodiment, the finalization processing is performed for a recording medium on which data is recorded in the first record format, as below. Subsequently, it becomes possible to identify details on video data recorded on a disk by using the known player.

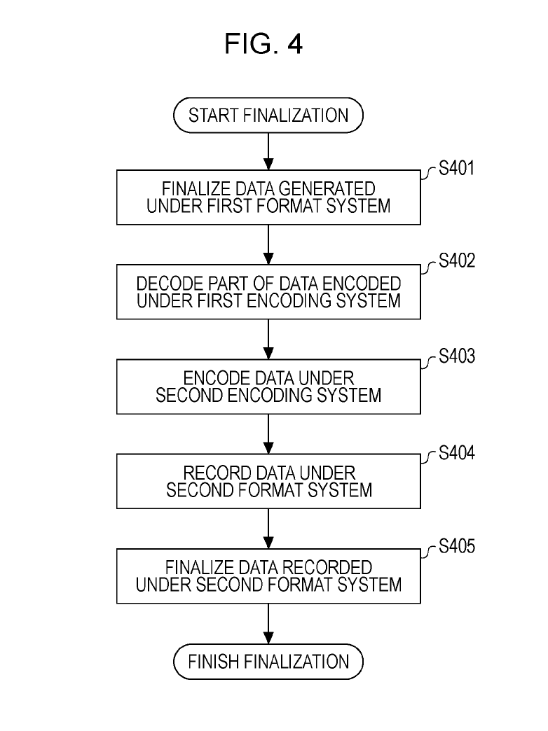

FIG. 4 is a flowchart illustrating procedures of the finalization processing according to the above-described embodiment. Upon receiving the instruction to perform the finalization processing, the instruction being transmitted from the operation unit 105 operated by the user, the finalization processing is started. At step S401, the controlling unit 106 performs the finalization processing according to the first record format. Namely, management information and/or menu data specified by the first record format is generated and recorded onto the recording medium 108 by the recording-and-reproducing unit 107.

Next, at step S402, the recording-and-reproducing unit 107 reads the stream files 206 recorded in the first record format from the recording medium 108 under the control of the controlling unit 106. Then, the decoding unit 103 decodes part of the stream files 206 (the first code strings) read by the recording-and-reproducing unit 107. For example, the decoding unit 103 decodes data on the first image of each of clips and generates data on a still image representing the clip.

Then, message information informing the user that a video signal is originally recorded onto the recording medium 108 in the first record format is provided. Then, the decoded representative-still-image data and the message information are merged into data on a message image used for the second record format.

Then, at step S403, the second encoding unit 109 re-encodes the message-image data generated, at step S402, in the second encoding system under the control of the controlling unit 106. Here, when the MPEG-2 Systems are used, as the second encoding system, as described above, the message-image data is converted into data on video played over a predetermined time period, and the video data is encoded under MPEG-2 Systems. Further, the clip-information file corresponding to the message-image data is also generated.

Then, at step S404, the controlling unit 106 records the second code string obtained through the encoding processing performed, at step S403, onto the recording medium 108 in the second record format by using the recording-and-reproducing unit 107. At that time, each of files (data strings) recorded in the second record format is recorded onto the recording medium 108 in the same form as the storage form shown in FIG. 3.

Namely, a directory (FORMAT_2) 207 indicating the second record format is provided under the root directory 201, as shown in FIG. 2. Then, a stream file 209 and the clip-information file 208 corresponding thereto that are generated, at step S403, are recorded under the root directory 207.

Finally, at step S405, the controlling unit 106 performs the finalization processing corresponding to the second record format so that the entire finalization processing is finished.

Here, as described above, the tree structure including the directory 207 and the files 208 and 209 is the same as the tree structure used in the known player, the tree structure including the directory 302 and the files 303 and 304 that are shown in FIG. 3. Therefore, the recording medium 108 subjected to the finalization processing according to the processing flow shown in FIG. 4 is properly identified by the known player and details on the message-image data stored in the directory 207 are reproduced.

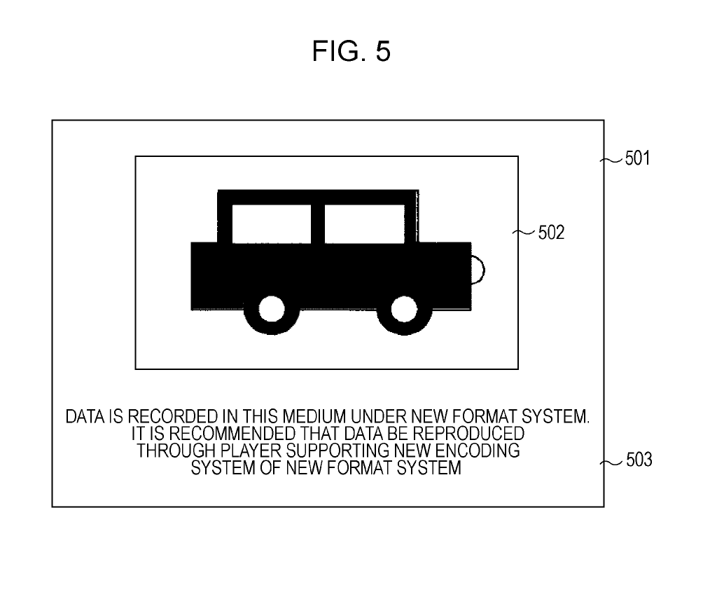

FIG. 5 shows an example screen image displayed when a recording medium subjected to the finalization processing in the above-described manner is inserted into the known player and reproduced.

As shown in FIG. 5, a representative image 502 of the video signals recorded onto the recording medium 108 in the first record format is displayed in a display-screen image 501. Further, in addition to the representative image 502, message video 503 generated (at step S403) is displayed in the display-screen image 501.

When the representative image 502 and the message video 503 are displayed, as shown in FIG. 5, the user can see details on video data recorded onto the recording medium 108 in the first record format by seeing the representative image 502. Further, the user can understand that the video signal is recorded onto the recording medium 108 in the first record format by seeing the message video 503.

Therefore, it becomes possible to make the user understand details on data recorded onto the recording medium 108, which makes it possible for the user to stop abandoning and/or initializing the recording medium 108 by mistake.

Thus, according to the first embodiment, video signals are recorded onto the recording medium 108 under the first encoding system and in the first record format. Then, during the finalization processing, part of the recorded video signals is recorded onto the recording medium 108 under the second encoding system and in the second record format, where the second encoding system and the second record format are used by the known players.

Accordingly, it becomes possible to record data reproduced with high quality over a long time period under the first encoding system and in the first record format. It becomes also possible to reproduce and display the data recorded onto the recording medium 108 by using the known player so that details on the recorded data can be identified.

Subsequently, it becomes possible for the user to understand details on data recorded onto the recording medium 108 and prevent the recording medium 108 from being abandoned and/or initialized by mistake.

Further, data on a still image representing clip information recorded in the first record format is re-encoded, at step S403 shown in FIG. 4. However, if the capacity of the recording medium 108 permits, part of the clip information recorded in the first record format may be re-encoded, as video, for example, without being limited to the above-described embodiment.

Further, if the capacity of the recording medium 108 is not adequate, data on a single still image only, the still-image data representing the recording medium 108, may be re-encoded.

On the other hand, only the message video can be generated and encoded without using an image obtained through the re-encoding processing. Although the message video alone is displayed, it becomes possible to prevent a fatal problem such as abandonment and/or initialization of the recording medium 108 from happening.

### Second Embodiment

Next, a second embodiment of the present invention will be described.

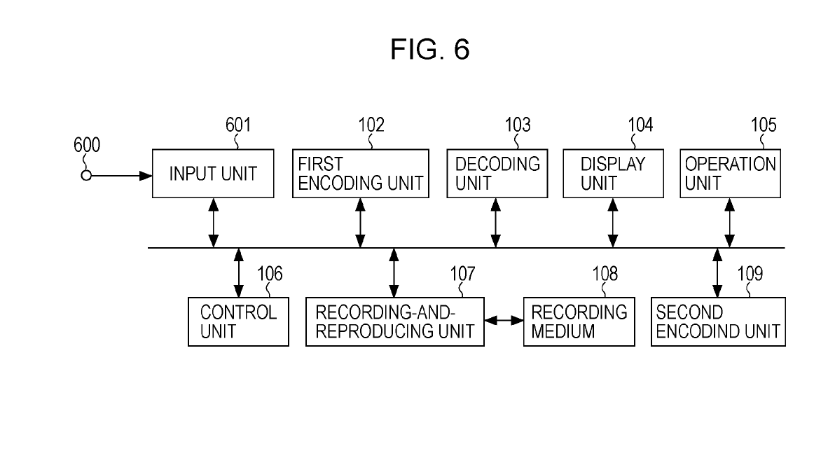

FIG. 6 is a block diagram showing an example configuration of a video-recording-and-reproducing apparatus using a signal-processing device according to the second embodiment. In FIG. 6, blocks having the same functions as those of the blocks shown in FIG. 1 are designated by the same reference numerals, and the same descriptions are not repeated.

The video-recording-and-reproducing apparatus shown in FIG. 6 includes a video-signal-input end 600 and an input unit 601.

The video-recording-and-reproducing apparatus of the above-described embodiment is operated when the user operates the operation unit 105 and the controlling unit 106 controls each of the blocks provided in the video-recording-and-reproducing apparatus in response to the operation.

That is to say, when the operation unit 105 issues an instruction to start recording, the input unit 601 receives a video signal transmitted from an external device such as a tuner (not shown) via the input terminal 600. The video signal transmitted to the input unit 601 is encoded by the first encoding unit 105 under the first encoding system so that the first code string is generated. The first code string is converted into data generated in the form corresponding to the first record format, and the recording-and-reproducing unit 107 records the data onto the recording medium 108. The above-described operations are performed repeatedly so that video-data items are recorded one after another onto the recording medium 108.

In the second embodiment, the finalization processing is performed for a recording medium on which a video signal is recorded in the first record format. At that time, the finalization processing is performed, as shown in FIG. 4, as is the case with the first embodiment.

Namely, the finalization processing is performed for the recording medium 108 so that the message-image data is recorded by using the same tree structure as the tree structure used by the known player, the tree structure including the directory 302, and the files 303 and 304.

Subsequently, the recording medium 108 subjected to the finalization processing can be correctly identified and data recorded onto the recording medium 108 can be reproduced by using the known player.

Namely, it becomes possible to record data played with high quality over a long time period under the first encoding system and in the first record format. It becomes also possible to reproduce and display the recorded data by using the known player so that details on the recorded data can be identified.

Therefore, it becomes possible for the user to understand details on data recorded onto the recording medium 108, which makes it possible for the user to stop abandoning and/or initializing the recording medium 108 by mistake.

### Other Embodiments

For making various types of devices operate, so as to achieve the functions of the above-described embodiments, program code (software) provided to achieve the above-described functions is supplied to a computer (a central processing unit (CPU) and/or a microprocessing unit (MPU)) provided in an apparatus and/or a system connected to the various devices. According to another embodiment of the present invention, the various types of devices are made to operate according to the program code stored in the computer of the system and/or the apparatus.

In that case, the program code itself achieves the functions of the above-described embodiments. Further, a section and/or a unit may be used to supply the program code to the computer, for example, a recording medium storing the program code. The recording medium storing the program code may be a flexible disk, a hard disk, an optical disk, a magneto-optical disk, a compact disk (CD)-read-only memory (ROM), a magnetic tape, a nonvolatile memory card, a ROM, and so forth.

Further, according to another embodiment of the present invention, the supplied program code achieves the functions of the above-described embodiments in association with an operating system and/or a different application software program or the like running on the computer.

Further, according to another embodiment of the present invention, the supplied program code is stored in a memory of a function extension board and/or a function extension unit relating to the computer, and a CPU or the like provided in the function extension board or the like performs part of or the entire processing which is actually performed according to instructions of the program code.

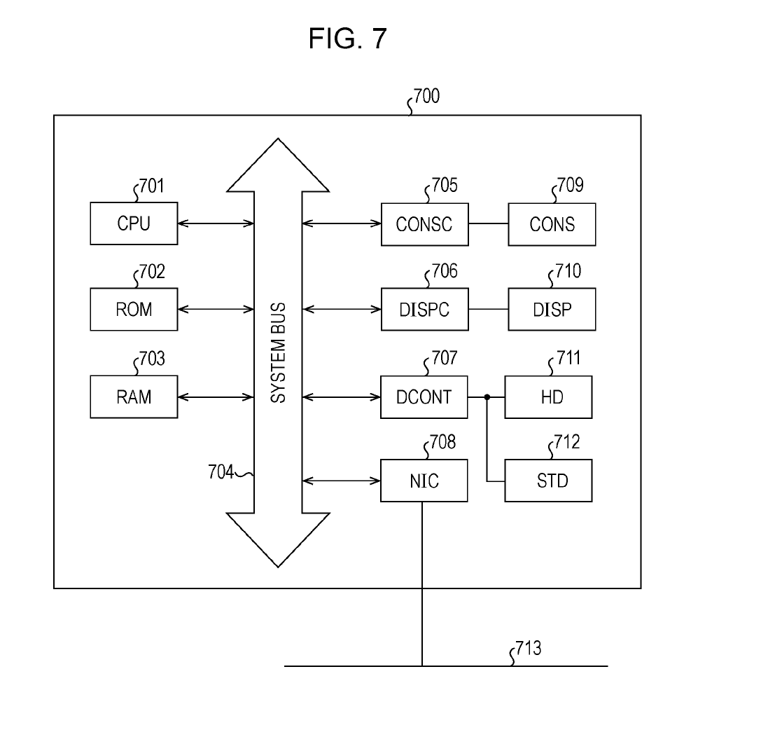

For example, the signal-processing device according to the first and second embodiments includes a computer function 700 shown in FIG. 7 and a CPU 701 of the computer function 700 performs the operations described in the first and second embodiments.

The computer function 700 includes a CPU 701, a read-only memory (ROM) 702, and a random-access memory (RAM) 703, as shown in FIG. 7. The computer function 700 further includes controller section (CONSC) 705 of a control section (CONS) 709, a display controller (DISPC) 706 of a display (DISP) 710 provided, as a display unit including a cathode-ray tube (CRT), a liquid-crystal display (LCD), and so forth. The computer function 700 further includes a controller (DCONT) 707 of a hard disk (HD) 711 and a storage device (STD) 712 including a flexible disk or the like, and a network interface card (NIC) 708. The above-described functional sections 701, 702, 703, 705, 706, 707, and 708 are connected to one another via a system bus 704 so that the above-described functional sections can communicate with one another.

The CPU 701 controls the functional sections connected to the system bus 704 by executing a software program stored in the ROM 702 and/or the HD 711, and/or a software program supplied from the STD 712. Namely, the CPU 701 performs control, so as to achieve the operations described in the first and second embodiments by reading a processing program provided to perform the above-described operations from the ROM 702, the HD 711, or the STD 712 and executing the read processing program. The RAM 703 functions, as a main memory and/or a work area or the like of the CPU 701.

The CONSC 705 controls an instruction input transmitted from the CONS 709. The DISPC 706 controls display processing performed by the DISP 710. The DCONT 707 controls accesses made to the above-described HD 711 and STD 712 storing a boot program, various types of application programs, user-file data, a network-management program, the above-described processing programs described in the first and second embodiments, and so forth. Data is bidirectionally transmitted between the NIC 708 and other devices provided on a network 713.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-279160 filed on Oct. 12, 2006, which is hereby incorporated by reference herein in its entirety.

What is claimed is:

1. A recording apparatus comprising:
a first encoding unit configured to encode a video signal under a first encoding system and generate first encoded data;
a recording unit configured to record the generated first encoded data onto a recording medium in a first record format;
a second encoding unit configured to encode a video signal under a second encoding system different from the first encoding system and generate second encoded data;
a finalization unit configured to perform finalization processing for the recording medium in the first record format based on an instruction to perform the finalization processing for the recording medium storing the first encoded data; and
a controlling unit configured to control the second encoding unit so that the second encoded data is generated by using the first encoded data recorded onto the recording medium and control the recording unit so that the generated second encoded data is recorded onto the recording medium storing the first encoded data in a second record format different from the first record format based on the instruction to perform the finalization processing for the recording medium storing the first encoded data.

2. A recording apparatus according to claim 1, further comprising:
a reproducing unit configured to reproduce the first encoded data from the recording medium; and
a decoding unit configured to decode the first encoded data reproduced by the reproducing unit and obtain a second video signal,
wherein the controlling unit controls the second encoding unit so that the second video signal is encoded under the second encoding system, and the second encoded data is generated, based on to the instruction to perform the finalization processing.

3. A recording apparatus according to claim 2, wherein the second encoding unit includes a unit configured to generate composite-video data by merging the second video signal and predetermined message information, and generates the second encoded data by encoding the composite-video data under the second encoding system.

4. A recording apparatus according to claim 1, wherein the second encoding unit generates the second encoded data by using part of the first encoded data recorded onto the recording medium.

5. A recording apparatus according to claim 1, wherein the recording unit stores the first encoded data in a first directory so that the first encoded data is recorded onto the recording medium, and stores the second encoded data in a second directory different from the first directory so that the second encoded data is recorded onto the recording medium.

6. A recording apparatus comprising:
a first encoding unit configured to encode a video signal under a first encoding system and generate first encoded data;
a recording unit configured to record the generated first encoded data onto a recording medium in a first record format;
a second encoding unit configured to encode a video signal under a second encoding system different from the first encoding system and generate second encoded data;
a finalization unit configured to perform finalization processing for the recording medium in the first record format based on an instruction to perform the finalization processing for the recording medium storing the first encoded data; and
a controlling unit configured to control the second encoding unit so as to generate the second encoded data relating to the first encoded data recorded onto the recording medium and control the recording unit so as to record the generated second encoded data onto the recording medium storing the first encoded data in a second record format different from the first record format based on the instruction to perform the finalization processing for the recording medium storing the first encoded data.
